(19) United States
(12) Patent Application Publication
(10) Pub. No.: US 2015/0324067 A1
(43) Pub. Date: Nov. 12, 2015

(54) VEHICLE INFOTAINMENT GATEWAY - MULTI-APPLICATION INTERFACE

(71) Applicant: Cesar Cabral, Los Angeles, CA (US)

(72) Inventor: Cesar Cabral, Los Angeles, CA (US)

(73) Assignee: HONDA MOTOR CO., LTD., Tokyo (JP)

(21) Appl. No.: 14/271,861

(22) Filed: May 7, 2014

(51) Int. Cl. G06F 3/0482; G06F 3/0481; G06F 3/0488; G06F 3/0484

(52) U.S. Cl. CPC G06F 3/0482; G06F 3/04842; G06F 3/04817; G06F 3/04847; G06F 3/04883

(57) ABSTRACT

Systems and methods of application management related to vehicle infotainment systems are discussed. One example system may include one or more application components, with each application component associated with a distinct software application. The example system may also include a history component maintaining a history of recently used applications from among the one or more application components. The history of recently used applications may be ordered based on times of most recent usage of the recently used applications. Additionally, the example system may include an application management component providing an application manager that facilitates selection among the one or more application components. The application manager may present a home screen and the history of recently used applications via an output component. The history of recently used applications may be updated based on user selection among the one or more application components.

### BACKGROUND

Vehicle infotainment systems provide drivers and passengers in vehicles with a unified system for accessing entertainment and various information services. Infotainment systems can provide a unified interface for occupants of a vehicle to interact with these entertainment and information services.

The available services of vehicle infotainment systems vary from system to system, but can include a car audio system (e.g., which can provide access to one or more of a radio, satellite radio, CD player, MP3 or other audio file player, etc.), a vehicle navigation system, in-car internet access, as well as other features (e.g., video players, etc.).

However, conventional vehicle infotainment systems have user interfaces that do not provide for ready access to various applications, a problem exacerbated as more features become available. In the case of use by the driver of a vehicle, increased interaction time with a vehicle infotainment system can pose safety concerns.

### SUMMARY

The following presents a simplified summary of the disclosure in order to provide a basic understanding of aspects of the disclosure. This summary is not an extensive overview of the disclosure. It is not intended to identify key/critical elements of the disclosure or to delineate the scope of the disclosure. Its sole purpose is to present concepts of the disclosure in a simplified form as a prelude to the more detailed description that is presented later.

The disclosure provided and claimed herein, in one aspect thereof, includes a vehicle infotainment system. One such example system may include one or more application components, with each application component associated with a distinct software application. The example system may also include a history component maintaining a history of recently used applications from among the one or more application components. The history of recently used applications may be ordered based on times of most recent usage of the recently used applications. Additionally, the example system may include an application management component providing an application manager that facilitates selection among the one or more application components. The application manager may present a home screen and the history of recently used applications via an output component. The history of recently used applications may be updated based on a user selection among the one or more application components.

In another aspect of the subject disclosure, methods of application management in vehicle infotainment systems are discussed. One example method may include the act of maintaining a history of recently used applications from among the one or more application components, wherein the history of recently used applications may be ordered based on times of most recent usage of the recently used applications. Additionally, such a method may include the act of providing an application manager that facilitates selection among the one or more application components. The application manager may present a home screen and the history of recently used applications via an output component. Such a method may also include the acts of receiving a selection of a selected application from the history of recently used applications and opening the selected application. The example method may also include the act of reordering the history of recently used applications based on the selection.

To the accomplishment of the foregoing and related ends, certain illustrative aspects of the disclosure are described herein in connection with the following description and the annexed drawings. These aspects are indicative, however, of but a few of the various ways in which the principles of the disclosure may be employed and the subject disclosure is intended to include all such aspects and their equivalents. Other advantages and novel features of the disclosure will become apparent from the following detailed description of the disclosure when considered in conjunction with the drawings.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 illustrates an exemplary vehicle infotaiment system in accordance with aspects of the subject disclosure.

FIG. 2 illustrates an exemplary method of application management in accordance with aspects of the subject disclosure.

FIG. 3 illustrates screenshots of an example embodiment of the subject disclosure implementing aspects described herein in accordance with aspects of the subject disclosure.

FIG. 4 illustrates an exemplary sequence of screenshots of an animation that may be associated with accessing the home page (or new application menu) in accordance with aspects of the subject disclosure.

FIG. 5 illustrates example screenshots associated with selection of applications through the home screen in accordance with aspects of the subject disclosure.

FIG. 6 illustrates example screenshots associated with selection of applications through the home screen in accordance with aspects of the subject disclosure.

FIG. 7 illustrates example screenshots associated with text searching in accordance with aspects of the subject disclosure.

FIG. 8 illustrates example screenshots associated with two alternative user interfaces for a vehicle infotainment system in accordance with aspects of the subject disclosure.

FIG. 9 illustrates example screenshots associated with an alternative user interface that allows for selection of the home screen via a fixed home button in accordance with aspects of the subject disclosure.

FIG. 10 illustrates an example steering wheel mounted interface and associated inputs that can be employed in various embodiments of the subject disclosure.

FIG. 11 illustrates an example workflow for management of a history of most recently used applications in accordance with aspects of the subject disclosure.

FIG. 12 illustrates a computer-readable medium or computer-readable device including processor-executable instructions configured to embody one or more of the provisions set forth herein, in accordance with aspects of the subject disclosure.

FIG. 13 illustrates a computing environment where one or more of the provisions set forth herein may be implemented, in accordance with aspects of the subject disclosure.

### DETAILED DESCRIPTION

The disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the disclosure may be practiced without these specific details. In other instances, well-known structures and devices are shown in block diagram form in order to facilitate describing the disclosure.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Furthermore, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives may be employed. The terms “screen,” “web page,” and “page” are generally used interchangeably herein. The pages or screens are stored and/or transmitted as display descriptions, as graphical user interfaces, or by other methods of depicting information on a screen (whether a dedicated display device associated with a vehicle infotainment system, a display device useable in connection with a vehicle infotainment system and one or more other systems or devices, a heads-up display, etc.) where the layout and information or content to be displayed on the page is stored in memory, database, or another storage facility.

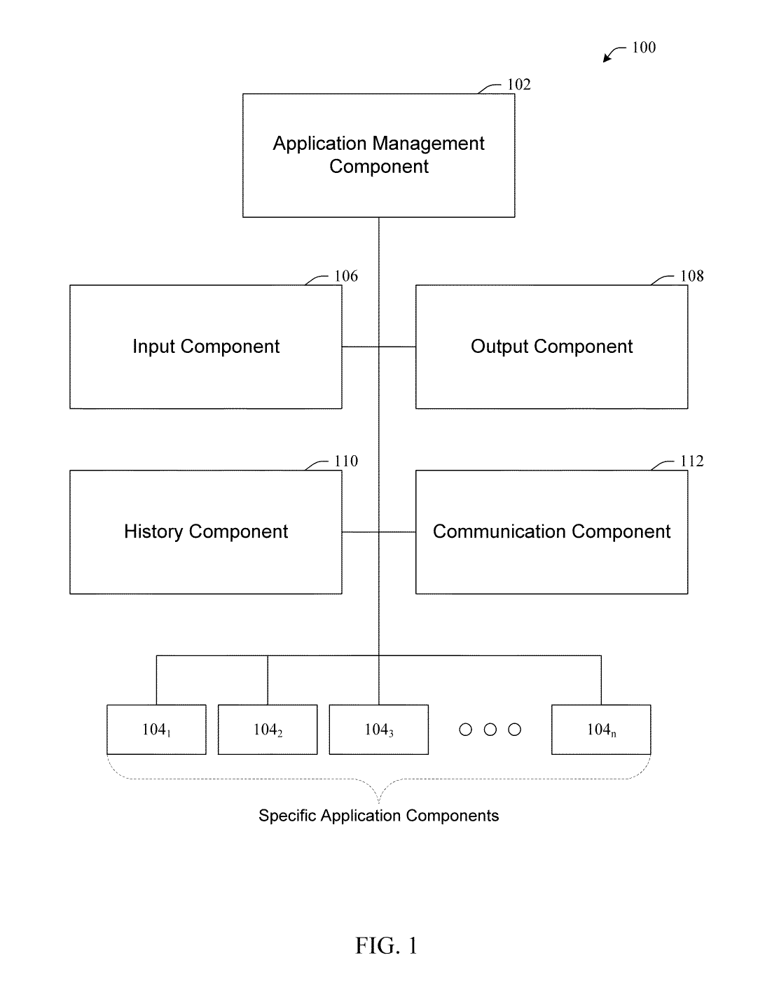

Referring initially to the drawings, FIG. 1 illustrates a vehicle infotaiment system 100 in accordance with aspects of the subject disclosure. System 100 may include an application management component 102 that may provide an application manager associated with the vehicle infotainment system, which facilitates user interaction with one or more specific application components 104 (e.g., applications related to one or more of audio, navigation, vehicle settings/information/diagnostics, other applications described herein, etc.), each of which can be associated with a distinct software application, which may provide application-specific functionalities as described herein and as will be understood by a person having ordinary skill in the art. The system 100 may include an input component 106 and output component 108, with input component 106 receiving user inputs in any of a variety of forms (e.g., voice, touch inputs, buttons or other manual inputs, from a paired device, etc.), and output component 108 providing outputs visually via a display (e.g., touchscreen, etc.), auditorily via speakers, wirelessly to a paired device, etc.

As users interact with system 100, history component 110 may maintain a history (e.g., as an ordered list) of the most recently used applications among application components 104, and may, in some embodiments, store additional information, such as a screenshot of each application in the history, etc. This history of recently used applications may be ordered based on times of most recent usage associated with each application in the history. In various aspects, the screenshot can visually represent the state of the application when it was most recently used. In other aspects, the screenshot can be updated periodically to reflect the state of an application running in the background while a user was directly interacting with or viewing a different application (e.g., listening to an audio application while selecting a location to navigate to, interacting with an audio application while following directions from a navigation application, etc.). In various aspects, such a screenshot can be updated as what that application would display changes, or less frequently (e.g., at regular intervals (e.g., 10 seconds, 1 minute, etc.), based on the occurrence of events (e.g., a current music track changes, a next navigation step is reached, etc.), etc.). In various aspects, the history may have a maximum number of entries maintained (e.g., the five most recent applications, etc.), while in other aspects, the size of the history may only be limited by the number of separate applications available to be in the history. As a user interacts with system 100, they may readily switch between a home screen or new application pane which presents access to all of the applications (e.g., in a hierarchical manner via menus, etc.) and applications stored in the history of recently used applications, which may present those applications in an order based on their position in the history of recently used application. In aspects, users may switch between the home screen and applications stored in the history in one or more ways, for example, with a touch input (e.g., swipe touchscreen horizontally (e.g., to the left or right), tap on left or right edge of touchscreen, etc.), voice input (e.g., “next,” “previous,” etc.), etc. In aspects, as a user selects applications, the history of recently used applications may be updated to reflect the new ordering of which applications have been most recently used. In some aspects, a user may be provided with an option to remove items from the history while browsing the history (e.g., by selecting an “x” attached to the screenshot, etc.).

A communication component 112 may be included in system 100, which may provide for the ability to communicate at least one of locally (e.g., with a paired device, etc.) or remotely (e.g., with one or more remote servers, to send or receive data related to one or more applications, such as navigation data, social media data, audio data, etc.).

In one embodiment, a user interacting with system 100 may access the home screen or new application pane by touch input by voice input, etc., and, if the history of recently used applications is not empty, a user may browse through the history as described herein after accessing the home screen. Example touch inputs to access the home screen can include tapping at the top edge of the screen, swiping down from the top, swiping or tapping all the way to one side when browsing through the history of recently used applications, etc. Example voice inputs can include words or phrases such as “home,” “new application,” “new task,” etc. Additionally or alternatively, in some aspects, a user may directly browse through the history from within an application (e.g., by tapping the edge of the screen, etc.).

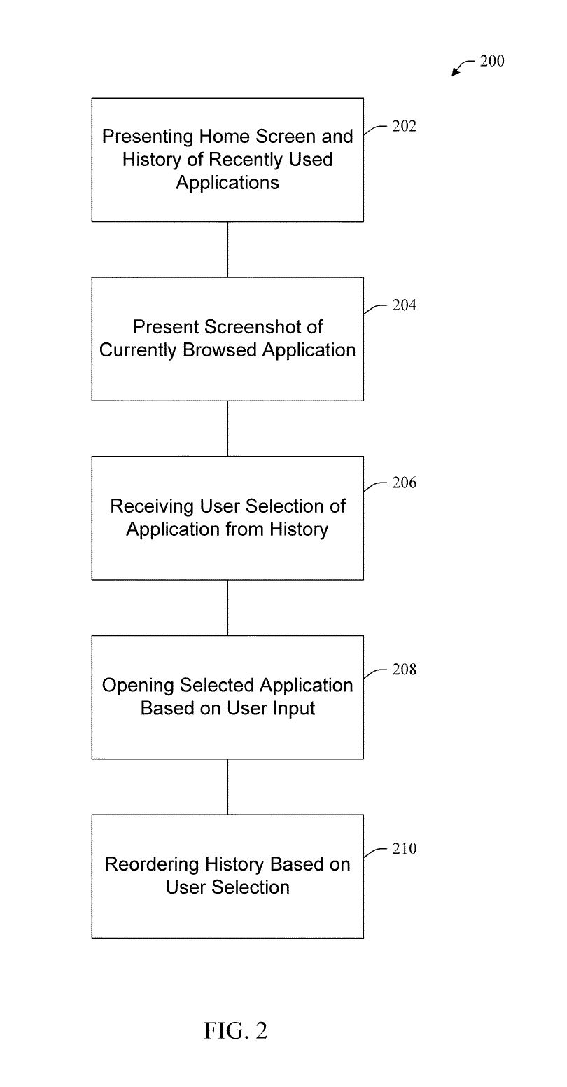

FIG. 2 illustrates a method 200 of application management in accordance with aspects of the subject disclosure. While, for purposes of simplicity of explanation, the one or more methodologies shown herein, e.g., in the form of a flow chart, are shown and described as a series of acts, it is to be understood that the subject disclosure is not limited by the order of acts, as various acts may, in accordance with the disclosure, occur in a different order and/or concurrently with other acts from that shown and described herein. For example, those skilled in the art will understand that a methodology could alternatively be represented as a series of interrelated states or events, such as in a state diagram. Moreover, not all illustrated acts may be required to implement a methodology in accordance with the disclosure.

Method 200 may begin at 202 by presenting a user with an application manager that may include a home screen and a history of recently used applications associated with a vehicle infotainment system. As a user browses through the history of recently used applications, a screenshot of a currently browsed application may be presented at 204. At 206, a user selection of an application from the history may be received. Based on that selection, at 208, the selected application may be opened. At 210, the history of recently used applications may be reordered based on the user selection, such that the selected application is moved to the top of the history.

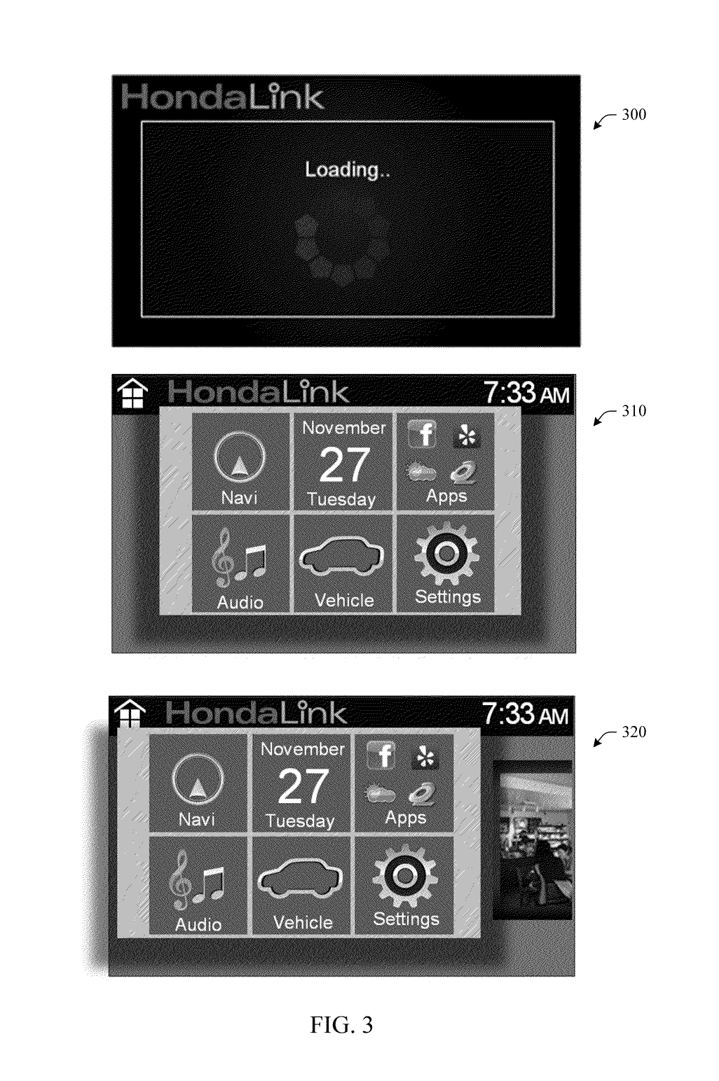

FIG. 3 illustrates screenshots 300, 310, and 320 of an example embodiment of the subject disclosure implementing aspects described herein. Image 300 shows an initial loading screen that may be presented by the example embodiment upon system startup, after which a home screen (or new application menu) may be displayed as in 310 if the history of recently used application is empty (e.g., if the system is being used for the first time, being used for the first time since being reset or all items otherwise removed from the history (e.g., each item deleted via user input, etc.)), while a home screen may be displayed along with a previous application pane (e.g., represented by a portion of a screenshot of a most recently used application) when the history of recently used application is non-empty, as seen at 320. The example home screen shown in 310 and 320 is just one possible embodiment, and displays a non-exhaustive list of example applications that may be used in connection with various embodiments of the subject disclosure, such as a navigation application, calendar application, audio application, vehicle application (e.g., for information, diagnostics, settings, etc.), a settings application that may allow a user to customize settings associated with the vehicle infotainment system (including pairing devices, accounts, etc.), and an additional menu for accessing further applications, such as social media applications, weather applications, etc. The home screen shown in 310 and 320 allows a user to select an application (whether on the history of recently used applications or not) to start the application through the home screen. As seen on the right side of 320, a previous application pane may be included as appropriate, which may allow a user to quickly select from recent applications. For example, a user may tap on the right side or swipe anywhere on the screen from right to left to recall the application, and in aspects, the most recent application may be shown next to the new application pane.

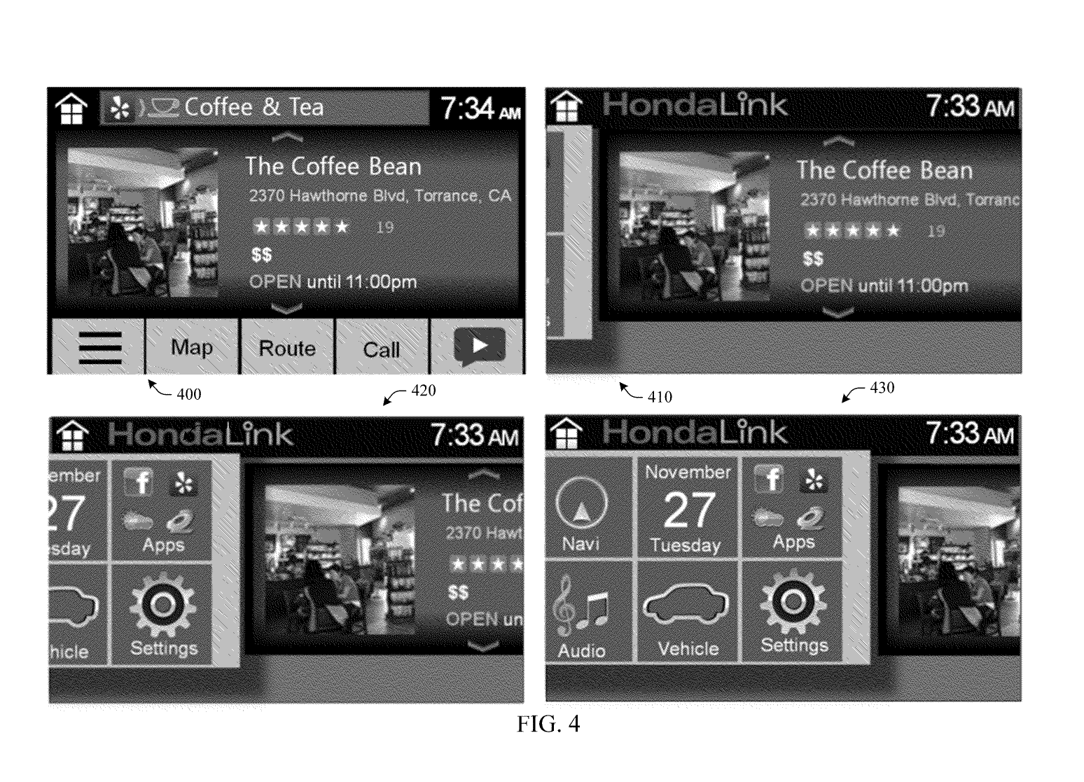

FIG. 4 illustrates a sequence of screenshots 400, 410, 420, and 430 of an animation that may be associated with accessing the home page (or new application menu) in accordance with an example embodiment of the subject disclosure. While the example vehicle infotainment system is running an application, as seen in 400, if the user selects the home screen (e.g., by tapping the header at the top of the touchscreen, etc.), then the home screen may move in from the left side of the screen as seen in the sequence of screenshots 410, 420, and 430, until the entire home screen is displayed along with the previous application pane, as in 320.

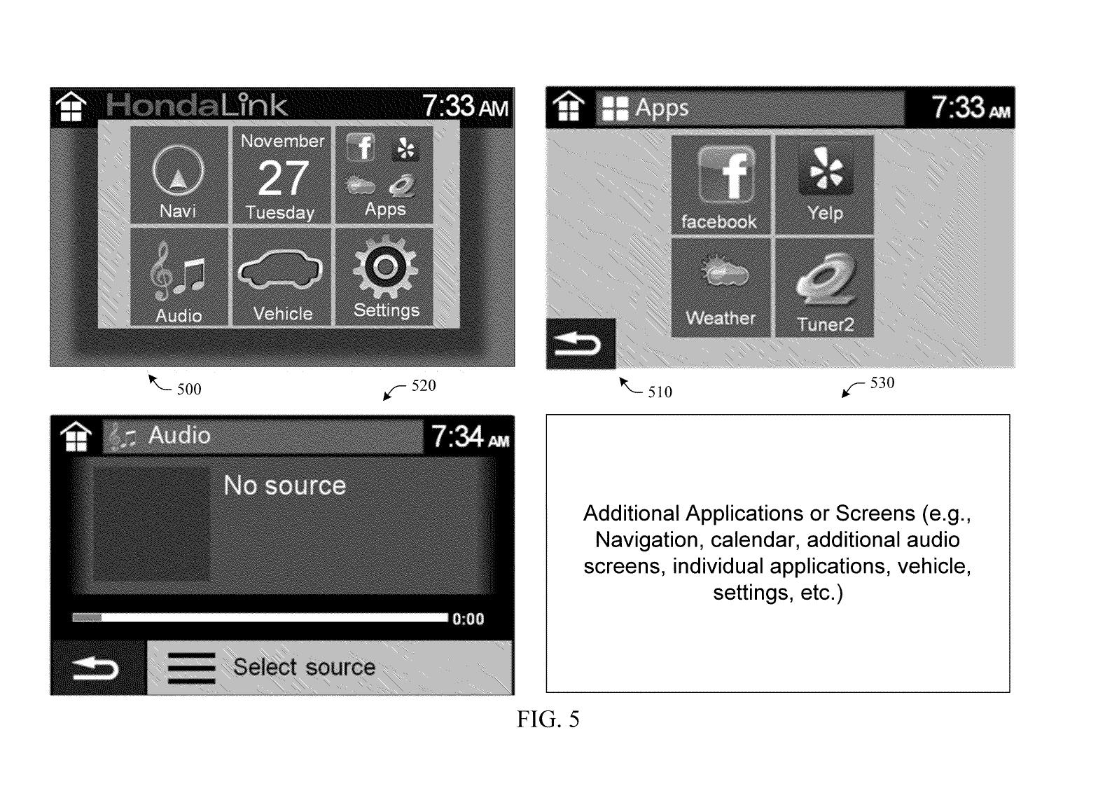

FIG. 5 illustrates example screenshots 500, 510, and 520 associated with selection of applications through the home screen in accordance with an example embodiment of the subject disclosure. The example home screen at 500 may be displayed in situations wherein there is not a current application history. From the home screen of 500, any of a variety of applications or menus may be selected, such as an application menu as shown at 510, an audio interface as shown at 520, or other applications as indicated at 530, such as that shown in 400, as well as others.

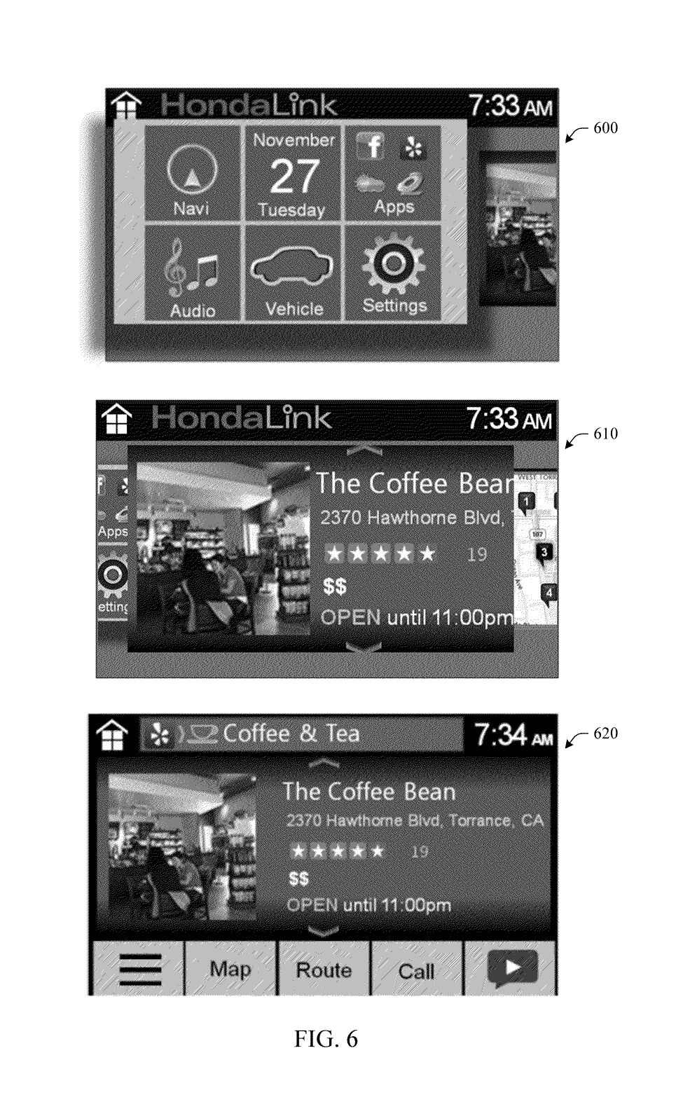

FIG. 6 illustrates example screenshots 600, 610, and 620 associated with selection of applications through the home screen in accordance with an example embodiment of the subject disclosure. 600 shows an example screenshot with a home screen and previous application pane. If the user browses through the history, a previous application may be shown, as in 610, showing a screenshot of a most recently used application, with the home screen represented to the left, and a second most recently used application on the right side. As a user selects an application via the history, that application may be opened, for example by expanding to a full screen size (as shown with the full screen example at 620) via an animation.

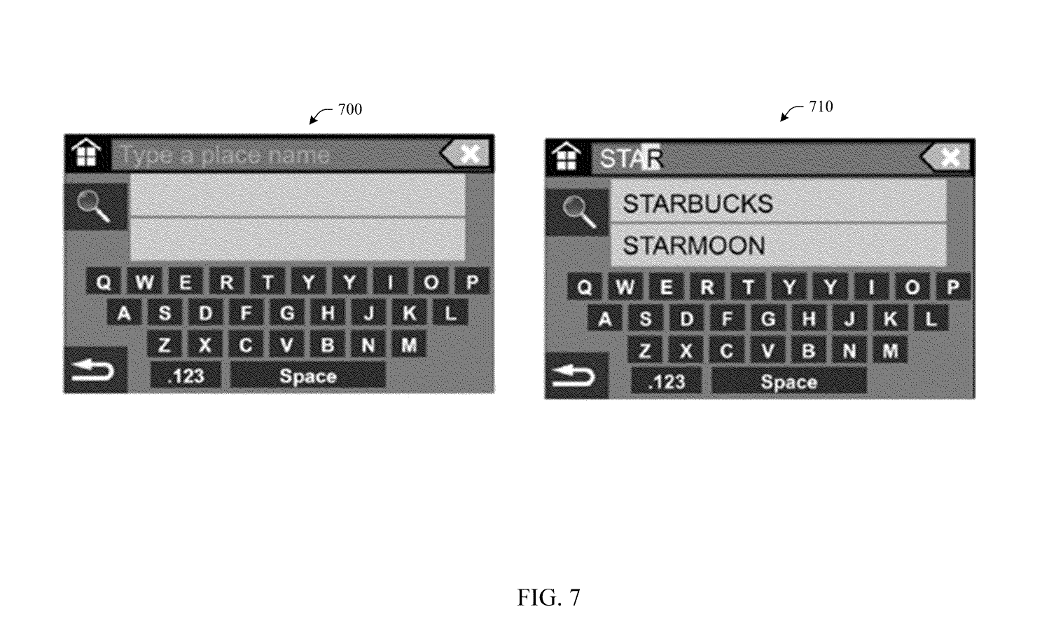

FIG. 7 illustrates example screenshots 700 and 710 associated with text searching in accordance with aspects of the subject disclosure. As can be seen in the upper left of each screenshot, the home screen (and history of recently used applications, if non-empty) can be accessed by tapping on an associated icon. In the bottom right of each screenshot, an area is provided to return to a prior application or portion of the home screen, etc.

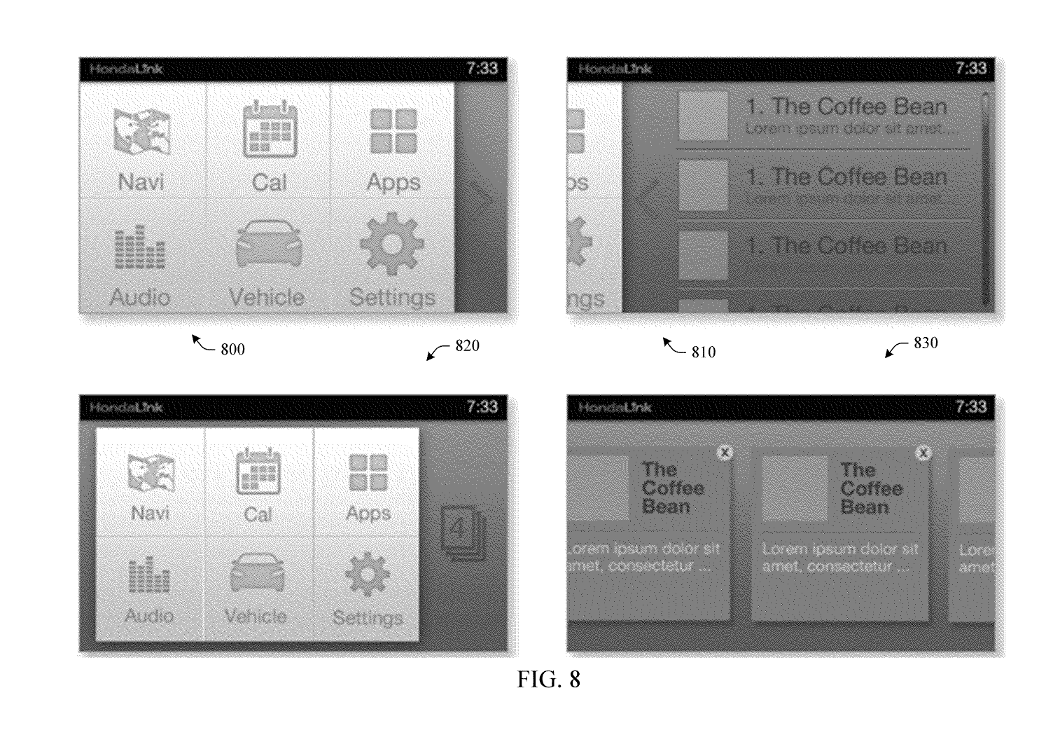

FIG. 8 illustrates example screenshots 800-830 associated with two alternative user interfaces for a vehicle infotainment system in accordance with aspects of the subject disclosure. In the example user interface shown in 800 and 810, the history of recently used applications can be presented in a more compact form, such as a list of application names (and potentially descriptions) that can be scrolled through (e.g., vertically, as seen in 810, horizontally, etc.). In an example user interface shown in 820 and 830, the previous ask pane can indicate a number of applications in the history (e.g., as seen on the right-hand side of 820). Additionally, as seen in 830, applications in the history may be displayed with a smaller screenshot than in the user interface shown in FIGS. 3-6, and can optionally include names and/or descriptions of the applications, as well as an optional icon to remove applications from the history (e.g., via the “x” at the upper right-hand corner of applications in the history, etc.).

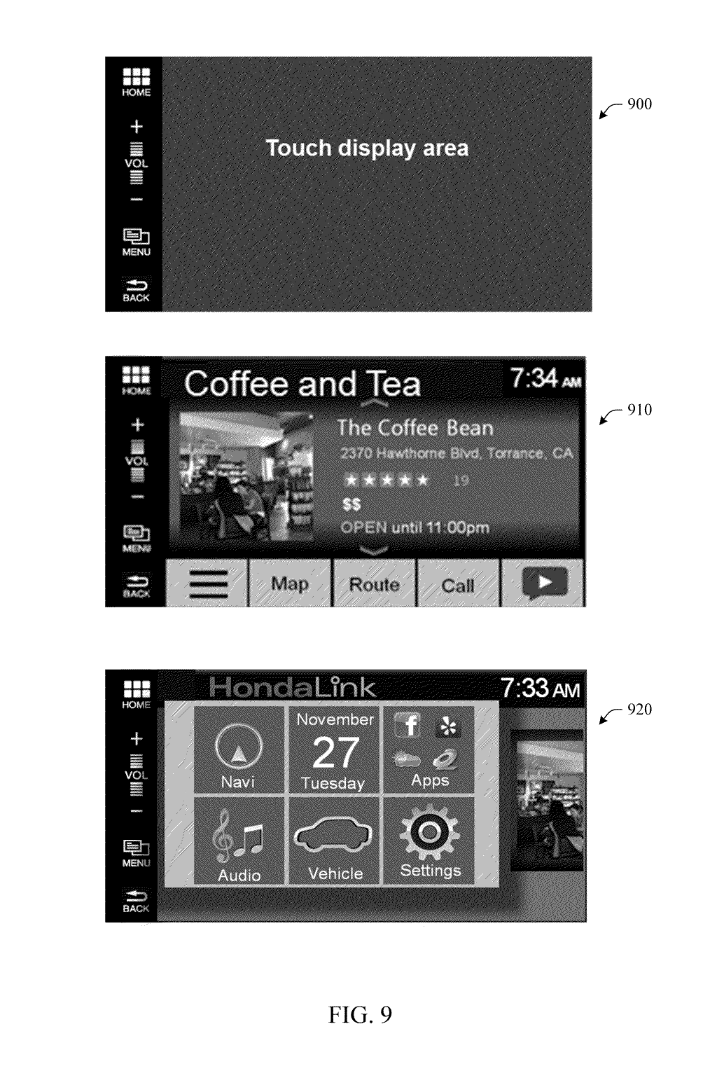

FIG. 9 illustrates example screenshots associated with an alternative user interface that allows for selection of the home screen via a fixed home button in accordance with aspects of the subject disclosure. In the example interface shown in FIG. 9, a side bezel can be included with a permanent home button for accessing the home screen regardless of what else is shown on the screen, as indicated in 900, showing the home button and additional interface controls (e.g., volume, a menu that can be context sensitive (e.g., based on current application, application state, etc.), and a back button, etc.) which can be displayed in connection with any additional content in the remainder of the touch display area. Images 910 and 920 show example interface images similar to those shown in 620 and 610, respectively, modified to incorporated the side bezel controls, including the permanent home button. Analogous animations to those shown and discussed in connection with FIG. 4 can be employed in embodiments using a bezel or permanent home button such as that shown in FIG. 9. In aspects, interface elements shown in FIG. 9 can be touchscreen elements, can be physical buttons, portions of a touchscreen, touch sensitive regions, etc.

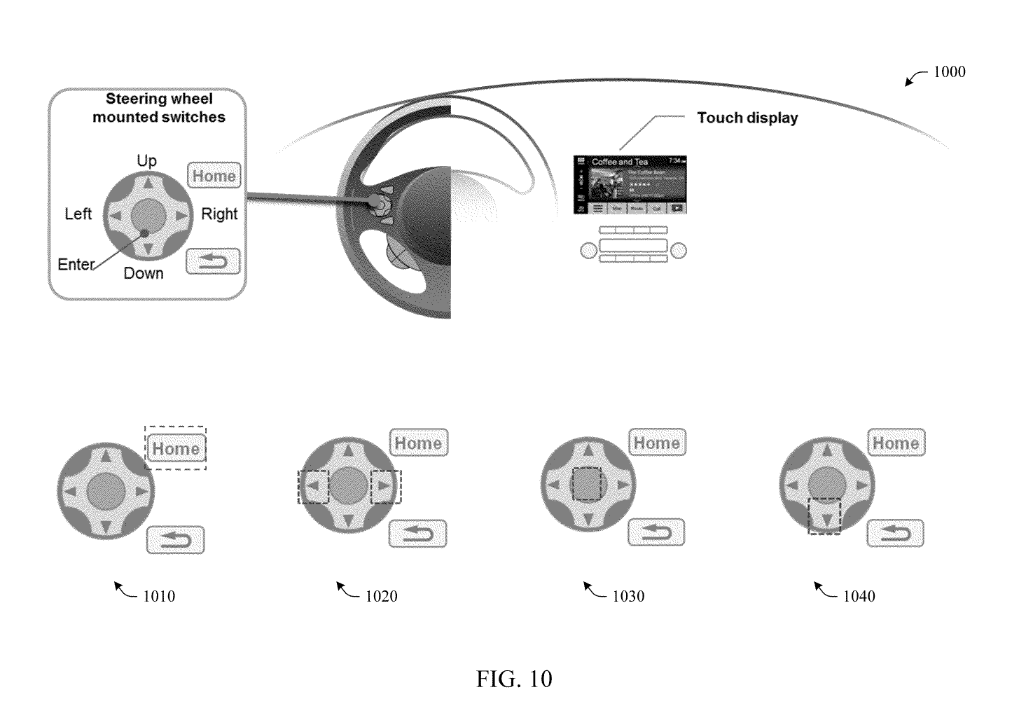

FIG. 10 illustrates an example steering wheel mounted interface and associated inputs that can be employed in various embodiments of the subject disclosure. As seen at 1000, an example steering wheel mounted interface can be included that includes physical buttons and/or switches (one of more of which can be context sensitive, etc.), such as with a directional pad and associated buttons. Images 1010 through 1040 show example inputs that can be used for navigation through user interfaces described herein in connection with aspects of the subject disclosure. For example, a home button can be selected as in 1010 to access the home screen from anywhere within the user interface described herein. The directional pad can be used to navigate within individual applications and between applications, such as by browsing between previous or next tasks in a task history by pressing to the left or right as shown at 1020. Individual tasks can be selected to expand as a current task (or items within tasks can be selected, e.g., individual search results from a list of results, etc.) by pressing the center button on the directional pad as shown at 1030. Tasks can be deleted from the task history by pressing down on the directional pad as shown in 1040.

It is to be understood that the user interfaces shown herein are included as examples for the purposes of illustration only, and not to limit the scope of the disclosure. In various aspects, user interfaces can be employed that have differing features or combinations thereof from those illustrated.

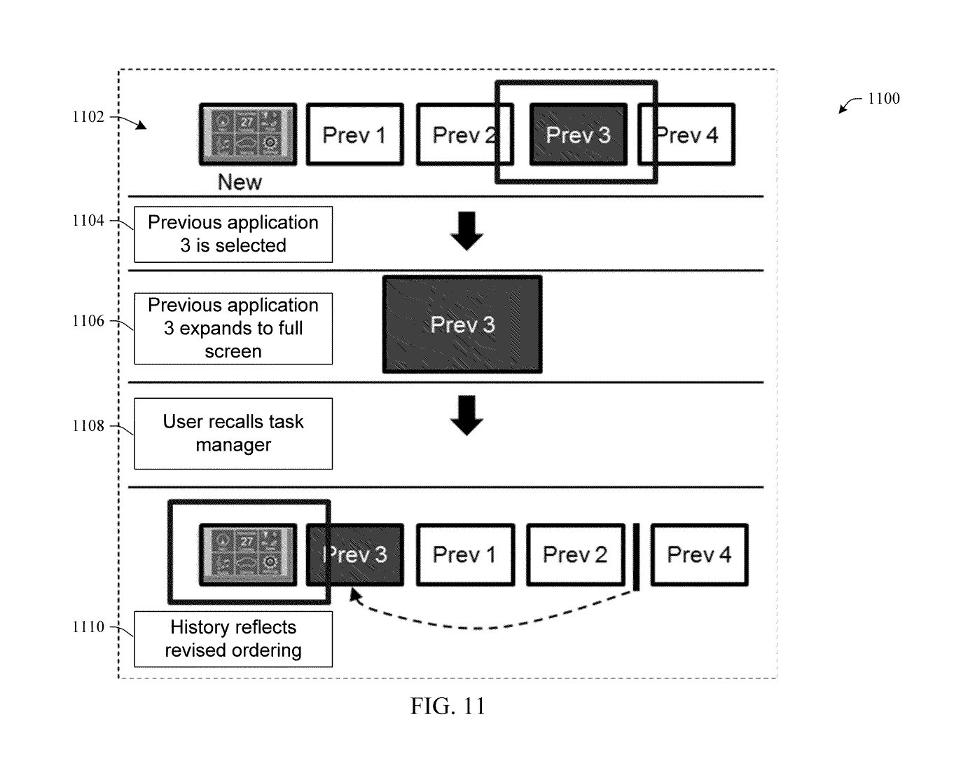

FIG. 11 illustrates an example workflow 1100 for management of a history of most recently used applications in accordance with aspects of the subject disclosure. This example workflow shows how applications may be organized from most recent to oldest, such that when an older application is recalled, the older application may be rearranged in the history and moved up to the most recent. The workflow may begin at 1102 by presenting a user with an application manager including a home screen and a history of recently used applications. In an example situation, a user may browse to a third most recently used application (labeled “Prev 3” in FIG. 11), and at 1104 may select that application. At 1106, the selected application may be resumed, and expanded to a full screen view for user interaction. At a later point, at 1108, the user may recall the application manager (e.g., home screen and history, etc.), which can reflect the revised ordering of applications based on which has been most recently used, as shown at 1110. Additionally, a screenshot associated with the now most recently used application (“Prev 3”) may be updated to reflect the most recent usage of that application.

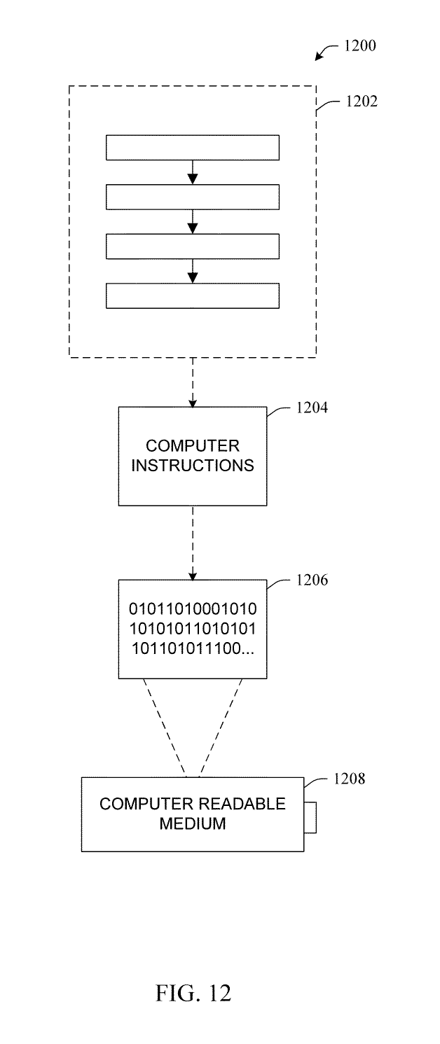

Still another embodiment may involve a computer-readable medium including processor-executable instructions configured to implement one or more embodiments of the techniques presented herein. An embodiment of a computer-readable medium or a computer-readable device that is devised in these ways is illustrated in FIG. 12, wherein an implementation 1200 comprises a computer-readable medium 1208, such as a CD-R, DVD-R, flash drive, a platter of a hard disk drive, etc., on which is encoded computer-readable data 1206. This computer-readable data 1206, such as binary data including a plurality of zero's and one's as shown in 1206, in turn comprises a set of computer instructions 1204 configured to operate according to one or more of the principles set forth herein. In one such embodiment 1200, the processor-executable computer instructions 1204 is configured to perform a method 1202, such as at least a portion of one or more of the methods described in connection with embodiments disclosed herein. In another embodiment, the processor-executable instructions 1204 are configured to implement a system, such as at least a portion of one or more of the systems described in connection with embodiments disclosed herein. Many such computer-readable media may be devised by those of ordinary skill in the art that are configured to operate in accordance with the techniques presented herein.

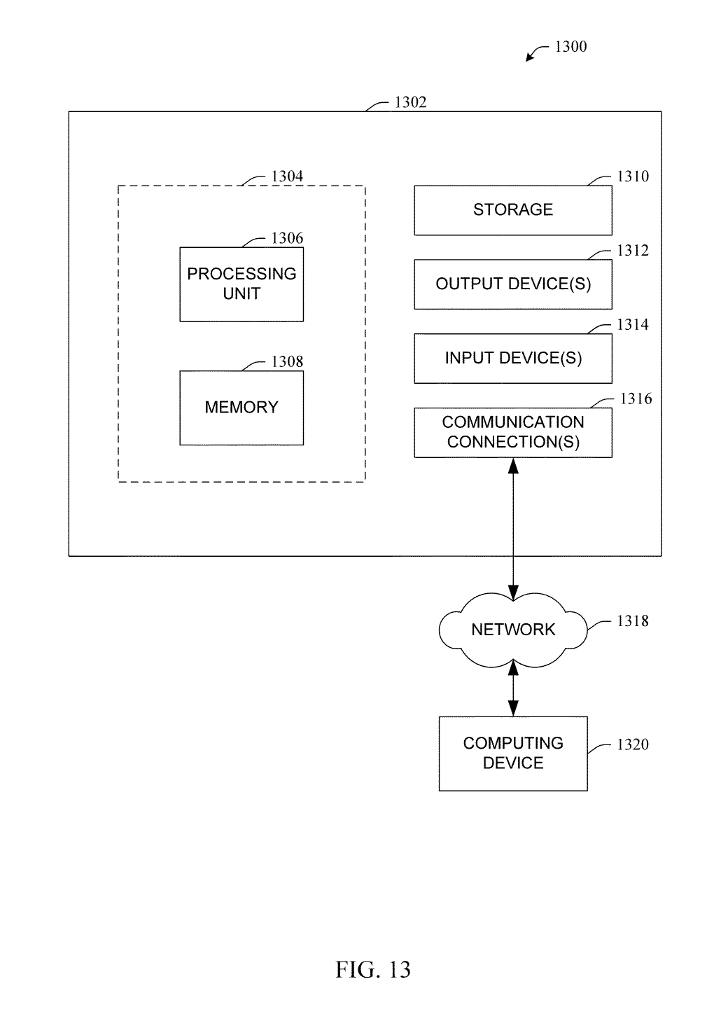

FIG. 13 and the following discussion provide a description of a suitable computing environment in which embodiments of one or more of the provisions set forth herein may be implemented. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates a system 1300 including a computing device 1302 configured to implement one or more embodiments provided herein. In one configuration, computing device 1302 may include at least one processing unit 1306 and memory 1308. Depending on the exact configuration and type of computing device, memory 1308 may be volatile, such as RAM, non-volatile, such as ROM, flash memory, etc., or a combination of the two. This configuration is illustrated in FIG. 13 by dashed line 1304.

In these or other embodiments, device 1302 may include additional features or functionality. For example, device 1302 may also include additional storage such as removable storage or non-removable storage, including, but not limited to, magnetic storage, optical storage, and the like. Such additional storage is illustrated in FIG. 13 by storage 1310. In various embodiments, computer readable instructions to implement one or more embodiments provided herein are in storage 1310. Storage 1310 may also store other computer readable instructions to implement an operating system, an application program, and the like. Computer readable instructions may be loaded in memory 1308 for execution by processing unit 1306, for example.

The term “computer readable media” as used herein includes computer storage media. Computer storage media includes volatile and nonvolatile, removable and non-removable media implemented in any method or technology for storage of information such as computer readable instructions or other data. Memory 1308 and storage 1310 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 1302. Any such computer storage media may be part of device 1302.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1302 may include one or more input devices 1314 such as keyboard, mouse, pen, voice input device, touch input device, infrared cameras, video input devices, or any other input device. One or more output devices 1312 such as one or more displays, speakers, printers, or any other output device may also be included in device 1302. The one or more input devices 1314 and/or one or more output devices 1312 may be connected to device 1302 via a wired connection, wireless connection, or any combination thereof. In various embodiments, one or more input devices or output devices from another computing device may be used as input device(s) 1314 or output device(s) 1312 for computing device 1302. Device 1302 may also include one or more communication connections 1316 that may facilitate communications with one or more other devices 1320 by means of a communications network 1318, which may be wired, wireless, or any combination thereof, and may include ad hoc networks, intranets, the Internet, or substantially any other communications network that may allow device 1302 to communicate with at least one other computing device 1320.

What has been described above includes examples of the disclosure. It is, of course, not possible to describe every conceivable combination of components or methodologies for purposes of describing the subject disclosure, but one of ordinary skill in the art may recognize that many further combinations and permutations of the disclosure are possible. Accordingly, the disclosure is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle infotainment system, comprising:
one or more application components, wherein each application component is associated with a distinct software application;
a history component maintaining a history of recently used applications from among the one or more application components, wherein the history of recently used applications is ordered based on times of most recent usage of the recently used applications; and
an application management component providing an application manager that facilitates selection among the one or more application components, wherein the application manager presents a home screen and the history of recently used applications via an output component,
wherein the history of recently used applications is updated based on user selection among the one or more application components.

2. The system of claim 1, comprising a touchscreen that receives user inputs associated with selection among the one or more application components.

3. The system of claim 2, wherein the application manager is provided in response to a press on a header portion of the touchscreen.

4. The system of claim 2, wherein the touchscreen displays an image that is one of an image corresponding to the home screen or an image corresponding to a currently browsed application from the history of recently used applications.

5. The system of claim 4, wherein the displayed image is changed in response to a horizontal swipe on the touchscreen.

6. The system of claim 4, wherein the displayed image is changed in response to a press on one of a left edge or a right edge of the touchscreen.

7. The system of claim 4, wherein the image corresponding to the currently browsed application comprises at least a portion of a screenshot associated with the currently browsed application.

8. The system of claim 7, wherein the screenshot is updated based on a status of the currently browsed application.

9. The system of claim 4, wherein the touchscreen additionally displays one of a previous application pane or a next application pane.

10. The system of claim 9, wherein the previous application pane comprises a portion of a screenshot associated with a previous application of the history and the next application pane comprises a portion of a screenshot associated with a next application of the history.

11. The system of claim 1, wherein the history of recently used applications comprises at most five applications.

12. The system of claim 1, wherein one or more applications are removed from the history of recently used applications in response to an input received an input component.

13. A method of facilitating selection among applications in a vehicle infotainment system, comprising:
maintaining a history of recently used applications from among the one or more application components, wherein the history of recently used applications is ordered based on times of most recent usage of the recently used applications;
providing an application manager that facilitates selection among the one or more application components, wherein the application manager presents a home screen and the history of recently used applications via an output component;
receiving a selection of a selected application from the history of recently used applications;
opening the selected application; and
reordering the history of recently used applications based on the selection.

14. The method of claim 13, wherein the selection is received via at least one of a touchscreen, a physical switch, a physical button, or a voice input.

15. The method of claim 14, comprising displaying an image on the touchscreen that is one of an image corresponding to the home screen or an image corresponding to a currently browsed application from the history of recently used applications.

16. The method of claim 15, comprising changing the displayed image in response to a horizontal swipe on the touchscreen.

17. The method of claim 15, comprising changing the displayed image in response to a press on one of a left edge or a right edge of the touchscreen.

18. The method of claim 15, wherein the image corresponding to the currently browsed application comprises at least a portion of a screenshot associated with the currently browsed application.

19. The method of claim 13, wherein the history of recently used applications comprises at most five applications.

20. The method of claim 13, comprising removing one or more applications from the history of recently used applications in response to a received input.
